(19) United States
(12) Patent Application Publication
(10) Pub. No.: US 2024/0403097 A1
(43) Pub. Date: Dec. 5, 2024

(54) FILTERS FOR ADVERTISED ROUTES FROM TENANT GATEWAYS IN A SOFTWARE-DEFINED DATA CENTER

(71) Applicant: VMWARE, INC., Palo Alto, CA (US)

(72) Inventors: CHANDAN GHOSH, Bangalore (IN); ABHISHEK GOLIYA, Pune (IN); NISARG PARIKH, Pune (IN)

(21) Appl. No.: 18/230,193

(22) Filed: Aug. 4, 2023

(30) Foreign Application Priority Data
Jun. 2, 2023 (IN) 202341038191

(51) Int. Cl. G06F 9/455

(52) U.S. Cl. CPC G06F 9/45558; G06F 2009/45595

(57) ABSTRACT

An example method of implementing a logical network in a software-defined data center (SDDC) includes: receiving, at a control plane, first configurations for first logical routers comprising advertised routes and a second configuration for a second logical router comprising a global in-filter, the global in-filter including filter rules, applicable to all southbound logical routers, which determine a set of allowable routes for the second logical router, the first logical routers connected to a southbound interface of the second logical router; determining, based on the filter rules, that a first advertised route is an allowed route; determining, based on the filter rules, that a second advertised route is a disallowed route; and distributing routing information to a host that implements at least a portion of the second logical router, the routing information including a route for the first advertised route and excluding any route for the second advertised route.

### RELATED APPLICATIONS

Benefit is claimed under 35 U.S.C. 119(a)-(d) to Foreign Application Serial No. 202341038191 filed in India entitled “FILTERS FOR ADVERTISED ROUTES FROM TENANT GATEWAYS IN A SOFTWARE-DEFINED DATA CENTER”, on Jun. 2, 2023, by VMware, Inc., which is herein incorporated in its entirety by reference for all purposes.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by control plane software that communicates with virtualization software (e.g., hypervisor) installed in the host computers. Applications execute in virtual computing instances supported by the virtualization software, such as virtual machines (VMs) and/or containers.

A network manager is a type of control plane software in an SDDC used to create a logical network. A logical network is an abstraction of a network generated by a user interacting with the network manager. The network manager physically implements the logical network as designed by the user using virtualized infrastructure of the SDDC. The virtualized infrastructure includes virtual network devices, e.g., forwarding devices such as switches and routers, or middlebox devices such as firewalls, load balancers, intrusion detection/prevention devices, and so forth that function as physical network devices except in software, typically in the hypervisor running n hosts, but may also be implemented by other physical components such as top-of-rack switches, gateways, etc. The virtualized infrastructure can also include software executing in VMs that connects with the virtual switch software through virtual network interfaces of the VMs. Logical network components of a logical network include logical switches and logical routers, each of which may be implemented in a distributed manner across a plurality of hosts by the virtual network devices and other software components.

A user can define a logical network to include multiple tiers of logical routers. The network manager can allow advertisement of routes from lower-tier logical routers to higher-tier logical routers. A user can configure route advertisement rules for the lower-tier logical routers and the higher-tier logical routers create routes in their routing tables for the advertised routes. This model works for uses cases where a user can control both the lower-tier logical routers and the higher-tier logical routers. The model is undesirable in other use cases, such as multi-tenancy uses cases. For example, in multi-tenant data centers, a lower tier logical router may be managed by a tenant of a multi-tenant cloud data center, whereas a higher tier logical router, interposed between the lower tier and an external gateway, may be managed by a provider of the multi-tenant cloud data center. Furthermore, multiple tenant logical routers may be connected to a single provider logical router. In the multi-tenancy use case, both tenant users and provider users need their own control of network policy. A tenant user wants to control which routes to advertise from tenant logical router(s), and a provider user wants to control which advertised routes to accept and which advertised routes to deny.

### SUMMARY

In an embodiment, a method of implementing a logical network in a software-defined data center (SDDC) is described. The method includes receiving, at a control plane of the SDDC, first configurations for first logical routers comprising advertised routes and a second configuration for a second logical router. The second configuration comprises a global in-filter. The global in-filter includes filter rules, applicable to all southbound logical routers, which determine a set of allowable routes for the second logical router. The first logical routers are connected to a southbound interface of the second logical router. The method includes determining, based on the filter rules, that a first advertised route is an allowed route. The method includes determining, based on the filter rules, that a second advertised route is a disallowed route. The method includes distributing, from the control plane, routing information to a host of the SDDC that implements at least a portion of the second logical router. The routing information includes a route for the first advertised route and excluding any route for the second advertised route.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1A is a block diagram depicting an exemplary computing system.

FIG. 1B is a block diagram depicting an exemplary logical network in the computing system of FIG. 1A.

FIG. 2 is a block diagram depicting an exemplary network management view of an SDDC having logical network.

FIG. 3 is a block diagram depicting an exemplary physical view of an SDDC.

FIG. 4A is a block diagram depicting an exemplary structure of a global in-filter for a provider logical router.

FIG. 4B is a block diagram depicting an exemplary structure of a rule in the global in-filter of FIG. 4A.

FIG. 5 is a block diagram depicting exemplary configurations provided by users to a control plane for logical network.

FIG. 6 is a block diagram depicting an exemplary logical operation of a control plane when processing advertised routes given a defined global in-filter.

FIG. 7 is a flow diagram depicting an exemplary method of implementing a logical network in an SDDC.

FIG. 8A depicts an example prefix list.

FIGS. 8B-8C depict example filter rules associated with the prefix list of FIG. 8A.

### DETAILED DESCRIPTION

Filters for advertised routes from tenant gateways in a software-defined data center (SDDC) are described. The SDDC includes workloads, which may comprise virtual machines, containers, or other virtualized compute endpoints, which run on physical server computers referred to as “hosts.” Control plane software (“control plane”) manages the physical infrastructure, including hosts, network, data storage, and other physical resources, and allocates such resources to the workloads. The hosts include hypervisor software that virtualize host hardware for use by workloads, including the virtual machines (VMs). Users may interact with control plane to define a logical network. The control plane implements the logical network by configuring the virtual switches, virtual routers, and other network infrastructure components, and may additionally configure software, e.g., agents, executing in VMs or on non-virtualized hosts. In a multi-tenancy example, the logical network includes multiple tier-1 logical routers (referred to herein as a “t1 router” but can also be referred to as “tenant logical routers”) connected to a tier-0 logical router, (referred to herein as a “t0 router” but can also be referred to as a “provider logical router”). The t1 routers implement route traffic for logical networks implemented in respective tenant network address spaces. The t0 router is outside of the tenant network address spaces and can be a provider gateway between an external network and the tenant gateways. Tenant users interact with the control plane to configure t1 routers. A provider user interacts with the control plane to configure the t0 routers.

A tenant user can configure a t1 router with advertised routes to the t0 router. In this manner, configurations received by the control plane from tenant users can include advertised routes to the t0 router from multiple t1 routers. A provider user supplies a configuration to the control plane that defines a global policy for advertised routes received at the t0 router from all downstream t1 routers in the form of a global in-filter. The global in-filter includes filter rules having an order of precedence. Each filter rule includes an action to be applied (e.g., allow or deny) to any advertised route for specified network address(es). Based on the global in-filter, the control plane generates routing information for the t0 router that includes routes for those advertised routes that are allowed and excludes routes for those advertised routes that are denied. The control plane distributes the routing information to the t0 router. In this manner, the provider user can define one global policy for advertised routes from all downstream t1 routers. These and further aspects of the techniques described herein are set forth below with respect to the drawings.

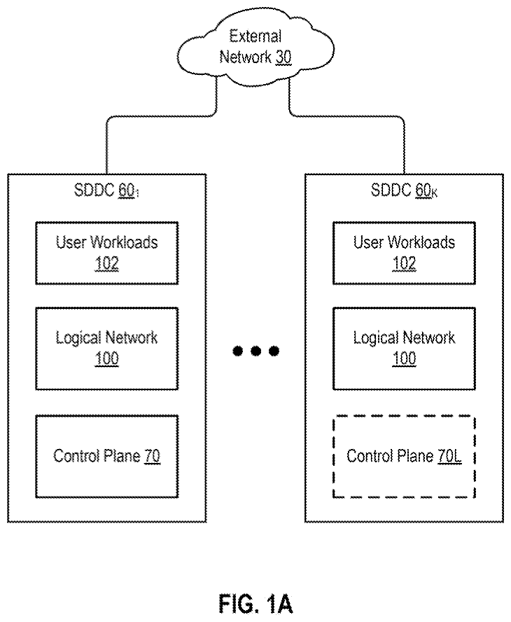

FIG. 1A is a block diagram depicting an exemplary computing environment. The computing environment includes at least one SDDC 60₁ . . . 60_{K}, connected to an external network 30, (where K is a positive integer indicating a number of SDDCs collectively referred to as SDDCs 60). External network 30 comprises a wide area network (WAN), such as the public Internet. SDDCs 60 can be implemented using physical hardware (e.g., physical hosts, storage, network) in one or more data centers, clouds, etc. Users deploy user workloads 102 in SDDCs 60. User workloads 102 includes users' software executing in virtual computing instances, such as VMs or containers. User workloads 102 communicate with each other and with external network 30 based on a logical network 100. The users interact with a control plane 70 to specify logical network 100. Control plane 70 physically implements logical network 100 using software executing on hosts, such as software that is part of hypervisors executing on hosts, software executing in virtual computing instances (e.g., VMs or containers), software executing on non-virtualized hosts, and combinations thereof. Although FIG. 1A shows discrete logical networks 100 in each SDDC 60, in reality, each SDDC may implement many logical networks, some or all of which may span, or stretch across, multiple ones of SDDCs 60.

Control plane 70 comprises software executing in the computing environment. In one example, control plane 70 executes in server hardware or virtual machines in one of the SDDCs 60 or in a third-party cloud environment (not shown) and implements logical network 100 across all or a subset of SDDCs 60. In another example, each SDDC 60 executes an instance of control plane software, where one instance is a global manager (e.g., control plane 70 in SDDC 60₁) and each other instance is a local manager (e.g., control plane 70L in each SDDC 60). In such an example, logical network 100 includes multiple instances, each managed locally by an instance of the control plane software, where the global manager also manages all instances of logical network 100.

A multi-tenancy system may distinguish between provider users and tenant users. For example, a provider user can manage SDDCs 60 as an organization or enterprise. Provider users create projects in organization, which are managed by tenant users. With respect to networking, provider users interact with control plane 70 to specify provider-level configurations for logical network 100, and tenant users interact with control plane 70 to specify tenant-level configurations for logical network 100. For example, tenant users may create policies applicable within their projects, while provider users may create policies applicable to individual projects, groups of projects, or all projects globally.

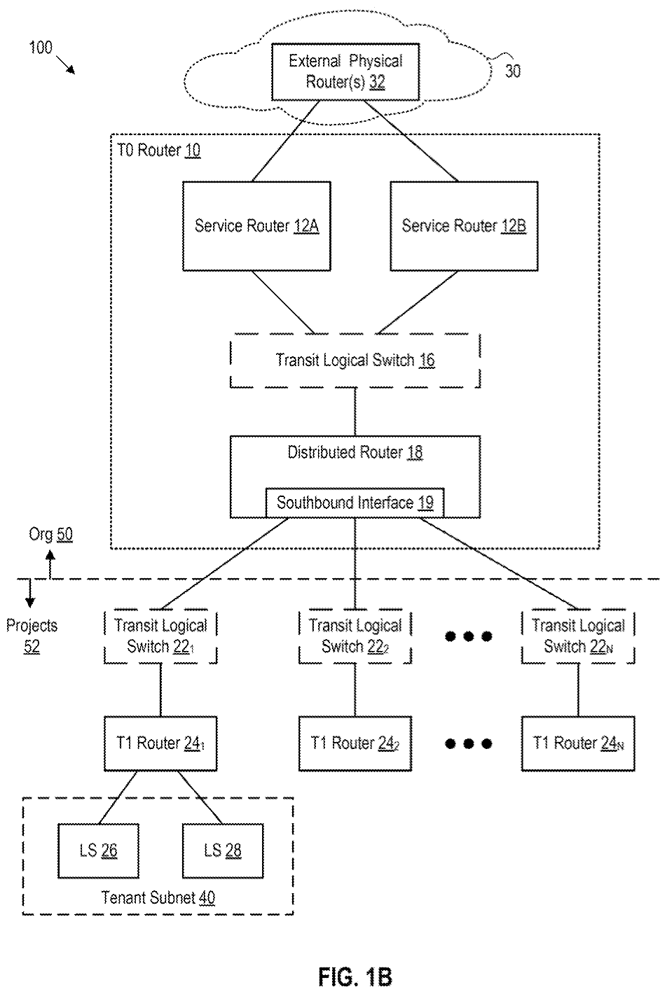

FIG. 1B is a block diagram depicting an exemplary logical network 100. Logical network 100 is a set of logically isolated overlay networks that is implemented across physical resources of a datacenter or a set of datacenters shown in FIGS. 1A and 2, and comprises a t0 router 10 and at least one t1 router 24₁ . . . 24_{N} (where N is a positive integer indicating a number of t1 routers in logical network 100, collectively referred to as t1 routers 24). In terms of hierarchy, t0 router 10 is a higher-tier logical router and t1 routers 24 are lower-tier logical routers.

Each t1 router 24 connects a tenant subnet with external networks. Each subnet includes an address space having a set of network addresses (e.g., Internet Protocol (IP) addresses). The set of network addresses in an address space can include one or more blocks (e.g., Classless Inter-Domain Routing (CIDR) blocks). In the example of FIG. 1B, a tenant subnet including logical switches 26, 28 is shown for t1 router 24₁. For purposes of illustration, the details of tenant address spaces for t1 routers 24 are omitted from FIG. 1B. Each t1 router 24ₙ connects to one or more logical switches. Each logical switch (LS) represents a particular set of network addresses in the tenant address space referred to variously as a segment, a sub-network, or a subnet. Virtual computing instances connect to logical ports of logical switches. In a tenant address space, logical switches also include logical ports coupled to a southbound interface of a respective t1 router. In the example of FIG. 1B, tenant address space 40 includes an LS 26 and an LS 28, each connected to t1 router 24₁.

T0 router 10 is outside of each tenant subnets. T0 router 10 and provide connectivity between external network 30 and an internal network space. T1 routers 24, logical switches connected to t1 routers 24, and virtual computing instances connected to the logical switches are in the internal network space. In terms of multi-tenancy, t0 router 10 is managed at an organization level (“org 50”) and t1 routers 24 are managed at a project level (“projects 52” within org 50). Other use cases (not shown) may have tenants that are not actually part of the org, but still subscribe to network services provided by the provider organization. Logical network 100 is specified by tenant users and/or provider users. Notably, project users specify configurations for t0 router 10 and tenant users specify configurations for t1 routers 24. Project users allocate address spaces for use as tenant address spaces by projects.

Northbound interfaces of t1 routers 24 are connected to a southbound interface 19 of t0 router 10. In the example, the northbound interfaces of t1 routers 24 are connected to southbound interface 19 through transit logical switches 22₁ . . . 22_{N}, (collectively referred to as transit logical switches 22) respectively. A transit logical switch is a logical switch created automatically by control plane 70 between logical routers. A transit logical switch does not have logical ports directly connected to user workloads 102. Control plane 70 may hide transit logical switches from view by users except for troubleshooting purposes. Each transit logical switch 22 includes a logical port connected to the northbound interface of a corresponding t1 router 24 and another logical port connected to southbound interface 19 of t0 router 10.

t0 router 10 can include multiple routing components. In the example, t0 router 10 includes a distributed routing component, e.g., distributed router 18, and centralized routing component(s), e.g., service routers 12A and 12B. A distributed router (DR) is responsible for first-hop distributed routing between logical switches and/or other logical routers that are logically connected to the DR. For example, t0 routers 10 may comprise DRs. A service router (SR) is responsible for delivering services that are not implemented in a distributed fashion (e.g., some stateful services, such as network address translation (NAT), centralized load balancing, dynamic host control protocol (DHCP), and the like). t0 router 10 includes one or more SRs as centralized routing component(s) (e.g., two SRs 12A and 12B are shown in the example). In examples, any t1 router can include SR(s) along with a DR. Control plane 70 (shown in FIG. 1A) specifies a transit logical switch 16 that connects a northbound interface of distributed router 18 to southbound interfaces of service routers 12A and 12B. Northbound interfaces of service routers 12A, 12B are connected to external physical router(s) 32 in external network 30.

FIG. 2 is a block diagram depicting an exemplary physical view of SDDC 60 for implementing logical network 100 (shown in FIGS. 1A, 1B). SDDC 60 includes hosts 210 having hypervisors (not shown) executing therein that support VMs 208. User workload applications 102 (see FIG. 1A) execute in VMs 208. Each host 210 also executes a managed forwarding element (MFE) 206. Each MFE 206 is a virtual switch that executes within the hypervisor of a host 210. SDDC 60 also includes edge services gateway (ESG) 202A and ESG 202B. Each ESG 202A, 202B may be implemented using gateway software executing directly on a physical host using the operating system of the physical host and no intervening hypervisor layer. Alternatively, each ESG 202A, 202B may be implemented using gateway software executing within a virtual machine. ESG 202B executes service router 12A and ESG 202B executes service router 12B. For example, on a virtualized host, a service router can execute in a VM. On non-virtualized host, a service router can execute as a process or processes managed by a host operating system (OS). Each ESG 202A, 202B also includes an MFE 206, which can execute as part of a hypervisor in a virtualized host or as host OS process(es) on a non-virtualized host. Hosts 210, ESGs 202A, 202B, and control plane 70 are connected to physical network 250.

Control plane 70 supplies data to MFEs 206 to implement distributed logical network components 214 of logical network 100. In the example, control plane 70 can configure MFEs 206 of hosts 210 and ESGs 202A, 202B to implement distributed router 18, t1 routers 24 and logical switches 16, 22, 26, and 28.

Control plane 70 includes a user interface (UI)/application programming interface (API) 220. Users or software interact with UI/API 220 to define configurations (configs) 222 for constructs of logical network 100. For example, tenant users can interact with control plane 70 through UI/API 220 to define configs 222 for t1 routers 24. A provider user can interact with control plane 70 through UI/API 220 to define configs for t0 router 10. Software executing in SDDC 60 can interact with control plane 70 through UI/API 220 to define/update configs 222 for constructs of logical network 100, including t1 routers 24 and t0 router 10. Control plane 70 maintains an inventory 224 of objects representing logical network constructs. Control plane 70 processes configs 222 as they are created, updated, or deleted to update inventory 224. Inventory 224 includes logical data objects 226 representing logical network components, such as t0 router 10, t1 routers 24, and logical switches 16, 22, 26, 28 in logical network 100. For t0 router 10, logical data objects 226 can include separate objects for service routers 12 and distributed router 18. Inventory 224 also includes objects for filters 227, which are defined in configs 222 and associated with logical data objects 226.

Filters 227 include t1 router out-filters 228, per-t1 router in-filters 230, advertisement out-filter 232, and global in-filter 234. The filters are applied in an order, e.g., t1 router out-filters 228, per-t1 router in-filters 230, global in-filter 234, and advertisement out-filter 232. In physical Layer-3 (L3) networks, routers exchange routing and reachability information using various routing protocols, including Border Gateway Protocol (BGP). A function of BGP is to allow two routers to exchange information representing available routes or routes no longer available. A BGP update for an advertisement of an available route includes known network address(es) to which packets can be sent. The network address(es) can be specified using an IP prefix (“prefix”) that specifies an IP address or range of IP addresses (e.g., an IPv4 prefix in CIDR form). For example, CIDR slash-notation can be used to advertise a single IP address using/32 (e.g., 10.1.1.1/32) or a range of IP addresses (e.g., 10.1.1/24). IPv6 (or future Layer 3 protocols) can be similarly supported. The physical routers can use incoming advertisements to calculate routes. For logical network 100, routes are calculated by control plane 70 and pushed down to forwarding elements (e.g., MFEs 206, SRs 12A, 12B) that handling routing. As control plane 70 controls how the forwarding elements will route packets, there is no need for the exchange of routing information between the forwarding elements and so logical routers may not exchange routing information using a routing protocol within logical network 100. As such, a user, interacting with control plane 70, specifies route advertisements in configs 222 and control plane generates routing information in response. A user can also specify filter(s) 227 that determine which advertised routes are allowed at a logical router, which to deny at a logical router, which to advertise again to other routers, and the like. Control plane 70 then generates routing information and pushes the routing information to the forwarding elements. SRs 12A, 12B, being connected to external physical router(s) 32, can execute a routing protocol (e.g., BGP) and advertise routes to external physical router(s) 32 and receive advertised routes from external physical router(s) 32.

A tenant user can interact with control plane 70 to define a config 222 with advertised route(s) from a t1 router 24. The tenant user can also define in config 222 a t1 router out-filter 228 for the t1 router 24. T1 router out-filter 228 lists network addresses that are permissible targets for route advertisements and/or which network addresses are impermissible targets for route advertisements. t1 router out-filters 228 are used by tenant users to set route advertisement policy for their respective projects 52. These project policies may be consistent with route advertisement policies for org 50 or inconsistent with such policies.

A provider user can interact with control plane 70 to define config(s) 222 with route advertisement policies of org 50. A provider user can define per-t1 router in-filters 230, each of which is associated with a specific one of t1 routers 24. That is, a per-t1 router in-filter 230 is associated with a particular logical port of southbound interface 19 of t0 router 10 and is only applicable to the t1 router connected to that logical port. A per-t1 router in-filter 230 lists a set of allowable routes for t0 router 10 that are advertised from the associated t1 router. If a tenant user configures a particular t1 router 24 to advertise a route, and a provider user configures a corresponding per-t1 router in-filter 230 that includes the advertised route in the set of allowable routes, then control plane 70 will add the advertised route to routing information for t0 router 10. In contrast, if the provider user configures per-t1 router in-filter 230 for the t1 router 24 that excludes the advertised route from the set of allowable routes, then control plane 70 will disallow the advertised route from inclusion in the routing information for t0 router 10.

In this manner, a provider user can restrict per-t1 router policies using per-t1 router in-filters for t0 router 10. A per-t1 router policy, however, is a policy for only the t1 router to which the per-t1 router policy applies. A provider user should have knowledge of each southbound t1 router and can implement an individual policy for each southbound t1 router. Moreover, tenants can create t1 routers for their projects independently from the provider user. In such case, the t1 routers may connect to t0 router 10 without the provider user having created corresponding per-t1 router in-filters 228 (since the provider user was not involved in creating the t1 routers). In such case, org policy would not be applied to these projects.

A provider user can further define an advertisement out-filter 232 for t0 router 10. Advertisement out-filter 232 restricts the routes that t0 router 10 advertises to external routers 32 (shown in FIG. 1B). Advertisement out-filter 232 is applied after all per-t1 router in-filters 228 and global in-filter 234 have been applied. In an example, advertisement out-filter 232 restrict which routes t0 router 10 can advertise based on route type (e.g., connected routes, static routes, routes associated with a specific service type, etc.). Advertisement out-filter 232 can also restrict which routes t0 router 10 advertises by source (e.g., from which t1 router the route was learned). Advertisement out-filter 232 can also restrict which routes t0 router 10 advertises to which peer routers. Thus, when control plane 70 adds new routes to the routing information for t0 router 10 based on route advertisements from t1 routers 24, advertisement out-filter 232 determines whether t0 router 10 will advertise those added routes using a routing protocol and to where those added routes should be routed. Advertisement out-filter 232, which restricts advertisement of routes to external routers by t0 router 10 based on type/source, is only applicable to routes already added to the routing information for t0 router 10 and does not restrict which routes may be added to the t0 routing tables based on advertisements from t1 routers.

A provider user can configure a global in-filter 234 for t0 router 10. Global in-filter 234 includes filter rules, applicable to all logical routers southbound of and connected to t0 router 10, which determine a set of allowable routes for t0 router 10. Global in-filter 234 is not specific to any one t1 router or any group of t1 routers or associated with any specific logical port of southbound interface 19. Rather, control plane 70 applies global in-filter 234 to all specified route advertisements for southbound logical routers (e.g., all t1 routers 24). If a tenant user configures any logical router connected to southbound interface 19 to advertise a route, and a provider user configures global in-filter 234 that includes the advertised route in the set of allowable routes, then control plane 70 will add the advertised route to routing information for t0 router 10. In contrast, if the provider user configures global in-filter 234 to exclude the advertised route from the set of allowable routes (or otherwise prohibit the advertised route) then control plane 70 will disallow the advertised route from inclusion in the routing information for t0 router 10. In an embodiment, a provider user can define a chain of global in-filters 234 comprising a generally applicable global in-filter and one or more specific global in-filters, where each specific global in-filter is associated with some path or tag associated with the advertised routes. The advertised routes can be applied to the chain of global in-filters with an apply action and exit on the first match. For example, a global in-filter 234 can be generally applicable to all advertised routes. Another global in-filter 234 can be applicable to only some advertised routes matching some criteria (e.g., a path of the router advertising the route, a tag associated with the router advertising the route, etc.).

Control plane 70 generates routing information for t0 router 10, which includes any advertised routes from t1 routers 24 that satisfy filters 227. The routing information can further include a list of routes to be advertised to peers by t0 router 10. Control plane 70 distributes the routing information to host(s) 210 and ESGs 202A, 202B to implement the configurations in t0 router 10. The routing information for MFEs 206 can comprise, for example, a routing table 212, or updates therefor, for distributed router 18. The routing information for service routers 12A, 12B can comprise, for example, routing tables 204A and 204B, or updates therefor, respectively.

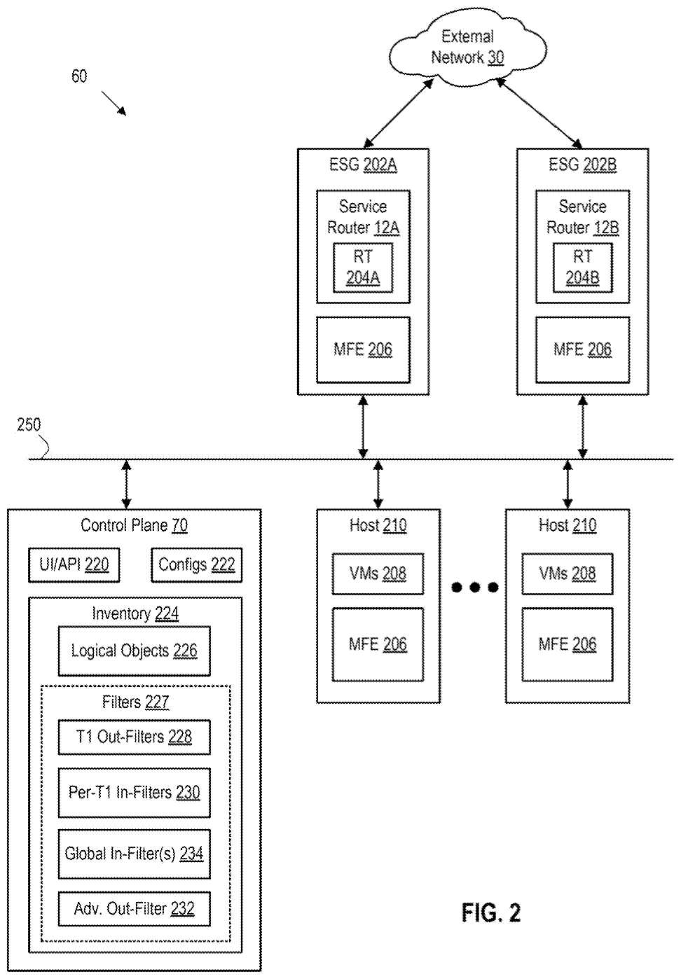

FIG. 3 is a block diagram depicting another exemplary physical view of SDDC 60. SDDC 60 includes a cluster of hosts 210 (“host cluster 318”) that may be constructed on hardware platforms such as x86 architecture platforms or ARM platforms of physical servers. For purposes of clarity, only one host cluster 318 is shown. However, SDDC 60 can include many of such host clusters 318. As shown, a hardware platform 322 of each host 210 includes conventional components of a computing device, such as one or more central processing units (CPUs) 360, system memory (e.g., random access memory (RAM) 362), one or more network interface controllers (NICs) 364, and optionally local storage 363. CPUs 360 are configured to execute instructions, for example, executable instructions that perform one or more operations described herein, which may be stored in RAM 362. NICs 364 enable host 210 to communicate with other devices through a physical network 250. Physical network 250 enables communication between hosts 210 and between other components and hosts 210.

In the example illustrated in FIG. 3, hosts 210 access shared storage 370 by using NICs 364 to connect to network 250. In another embodiment, each host 210 contains a host bus adapter (HBA) (not shown) through which input/output operations (IOs) are sent to shared storage 370 over a separate network (not shown). Shared storage 370 include one or more storage arrays, such as a storage area network (SAN), network attached storage (NAS), or the like. Shared storage 370 may comprise magnetic disks, solid-state disks, flash memory, and the like as well as combinations thereof. In some embodiments, hosts 210 include local storage 363 (e.g., hard disk drives, solid-state drives, etc.). Local storage 363 in each host 210 can be aggregated and provisioned as part of a virtual SAN, which is another form of shared storage 370.

Software 324 of each host 210 provides a virtualization layer, referred to herein as a hypervisor 328, which directly executes on hardware platform 322. Hypervisor 328 abstracts processor, memory, storage, and network resources of hardware platform 322 to provide a virtual machine execution space within which multiple virtual machines (VM) 208 may be concurrently instantiated and executed, User workloads 102 execute in VMs 208 either directly on guest operating systems or using containers on guest operating systems. Hypervisor 328 includes MFE 206 (e.g., a virtual switch) that provides Layer 2 network switching and other packet forwarding functions. Additional network components that may be implemented in software by hypervisor 328, such as distributed firewalis, packet filters, overlay functions including tunnel endpoints for encapsulating and de-encapsulating packets, distributed logical router components and others are not shown. VMs 208 include virtual NICs (vNICs) 365 that connect to virtual switch ports of MFE 206. MFEs 206, along with other components in hypervisors 328 implement distributed logical network components 214 shown in FIG. 1B, including distributed router 18. t1 routers 24, logical switches 16, 22, 26, and 28.

ESGs 202 comprise virtual machines or physical servers having edge service gateway software installed thereon. ESGs 202 execute service routers 12A, 12B of FIG. 1B.

Returning now to FIG. 3, a virtualization manager 310 manages host cluster 318 and hypervisors 328. Virtualization manager 310 installs agent(s) in hypervisor 328 to add a host 210 as a managed entity. Virtualization manager 310 logically groups hosts 210 into host cluster 318 to provide cluster-level functions to hosts 210. The number of hosts 210 in host cluster 318 may be one or many. Virtualization manager 310 can manage more than one host cluster 318. SDDC 60 can include more than one virtualization manager 310, each managing one or more host clusters 318.

SDDC 60 further includes a network manager 312. Network manager 312 installs additional agents in hypervisor 328 to add a host 210 as a managed entity. Network manager 312 executes at least a portion of control plane 70. In some examples, host cluster 318 can include one or more network controllers 313 executing in VM(s) 208, where network controller(s) 313 execute another portion of control plane 70.

In examples, virtualization manager 310 and network manager 312 execute on hosts 302, which can be virtualized hosts or non-virtualized hosts that form a management cluster. In other examples, either or both of virtualization manager 310 and network manager 312 can execute in host cluster 318, rather than a separate management cluster.

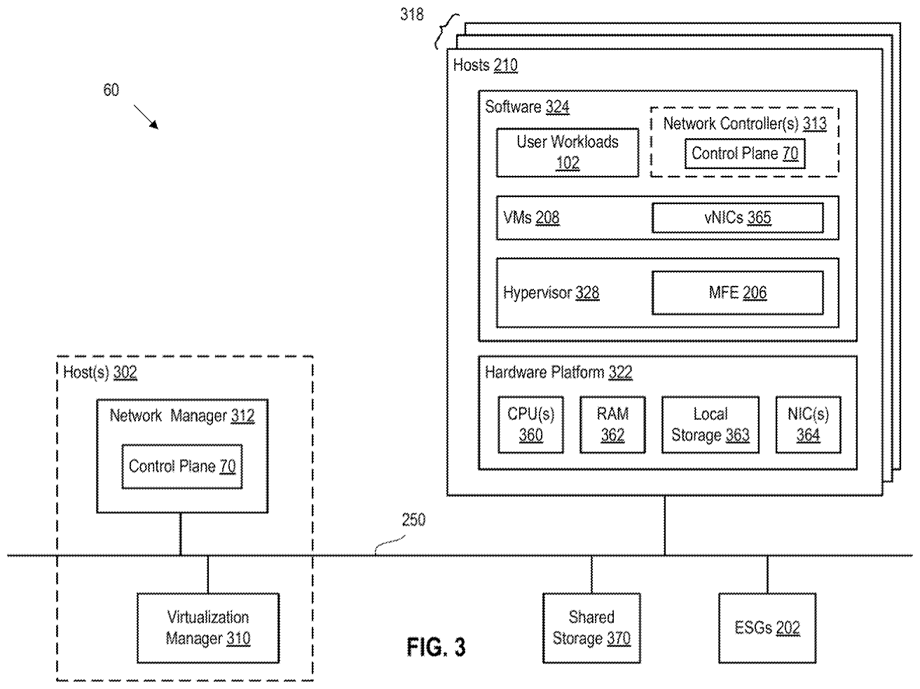

FIG. 4A is a block diagram depicting an exemplary structure of global in-filter 234. Global in-filter 234 includes prefix lists 402 and filter rules 408. A prefix list 402 includes prefixes 404 that define a set of network addresses (e.g., as may be defined using CIDR slash notation). A prefix list 402 can optionally include a default action 406 associated with prefixes 404. Filter rules 408 include a set of rules 410₁ . . . 410_{M}, where M is a positive integer. Filter rules 408 can be applied in an order of precedence. In the example, set of rules 410₁ . . . 410_{M} includes rules 1 through (M−1) in decreasing order of precedence, plus a default rule 410_{M} that has the lowest precedence. Thus, rules 410₁ . . . 410_{M} can be arranged in order of highest precedence to lowest precedence. Control plane 70 applies filter rules 408 in order of precedence to each advertised route from southbound logical routers. Default rule 410_{M} can allow or deny any advertised route for which rules 410₁ . . . 410_{(M-1)} do not apply.

FIG. 4B is a block diagram depicting an exemplary structure of a rule 410ₘ (mε{1 . . . M}). Rule 410ₘ optionally specifies a prefix list 402. If no prefix list 402 is specified, rule 410ₘ is applied to any advertised route. Rule 410ₘ, can optionally specify a scope 412 and/or an action 414. Scope 412 can limit application of rule 410ₘ to one or more specific southbound logical routers (selected logical router(s)). If no scope 412 is specified, then rule 410ₘ applies to all southbound logical routers. Action 414 can override default action 406 of prefix list 402 if included, or be specified if prefix list 402 is not included or does not include a default action 406.

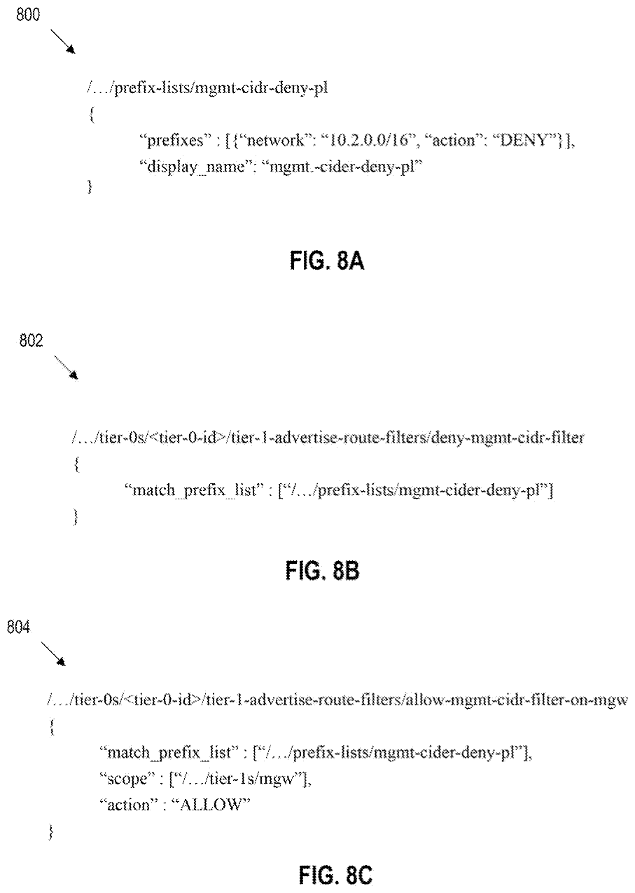

FIG. 8A depicts an example prefix list 800. 14gmt.14gmt. In this example prefix list, the prefix 10.2.0.0/16 is associated with a default rule DENY. In this example, the prefix list is defined in a file “mgmt-cidr-deny-pl” having that path/ . . . /prefix-lists/mgmt-cidr-deny-pl. As shown in FIG. 8B, the provider user can define a filter rule 802.

In this example rule for a t0 router having an identifier <t0-id>, the prefix list “/ . . . /prefix-lists/mgmt-cidr-deny-pl” is specified without a scope or action. Thus, the rule applies the default action of the prefix list to any advertised route, from any southbound logical router, from a network address that matches the prefixes (action==DENY). As shown in FIG. 8C, the provider user can further define a filter rule 804.

In this example rule for a t0 router having an identifier <tier-0-id>, all advertised routes from a network address that matches the prefix list “/ . . . /prefix-lists/mgmt-cidr-deny-pl”, from t1 router with identifier “/ . . . /tier-ls/mgw” are allowed. The rule includes an action (ALLOW) that overrides the default action of the specified prefix list. The rule “/ . . . /tier-0s/<tier-0-id>/tier-1-advertise-route-filters/allow-mgmt-cidr-filter-on-mgw” can have a higher precedence than the rule “/ . . . /tier-0s/<tier-0-id>/tier-1-advertise-route-filters/deny-mgmt-cidr-filter.”

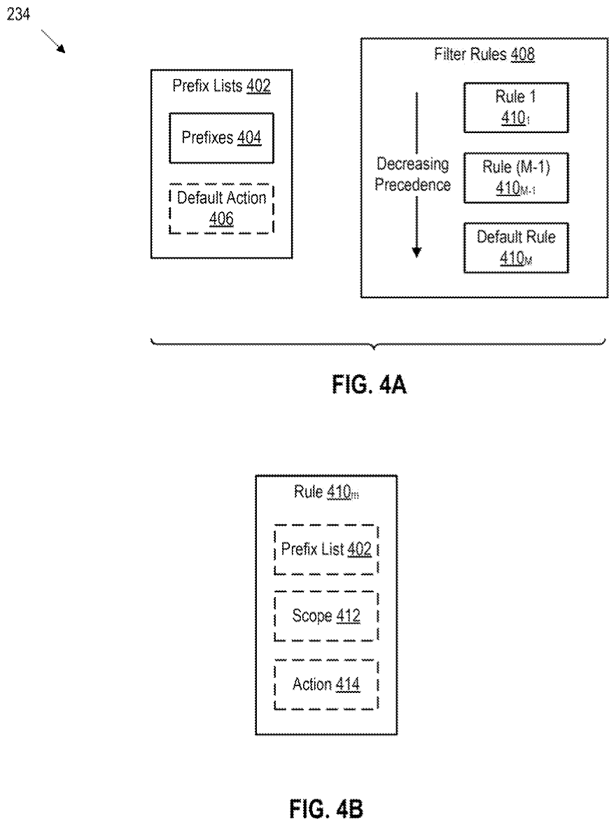

FIG. 5 is a block diagram depicting exemplary configurations 222 provided by users to control plane 70 for logical network 100. A tenant user creates a config 222A that includes a t1 router definition 502 to create or update a t1 router 24 in logical network 100. Config 222A also includes advertised routes 504, which includes a set of advertised routes for the t1 router. A provider user creates a config 222B that includes a t0 router definition 506 to create or update t0 router 10 in logical network 100. Config 222B includes a global in-filter definition 508. Global in-filter definition 508 can include one or more filter rules 408. Global in-filter 508 can further include one or more prefix lists 402 referenced by filter rules 408.

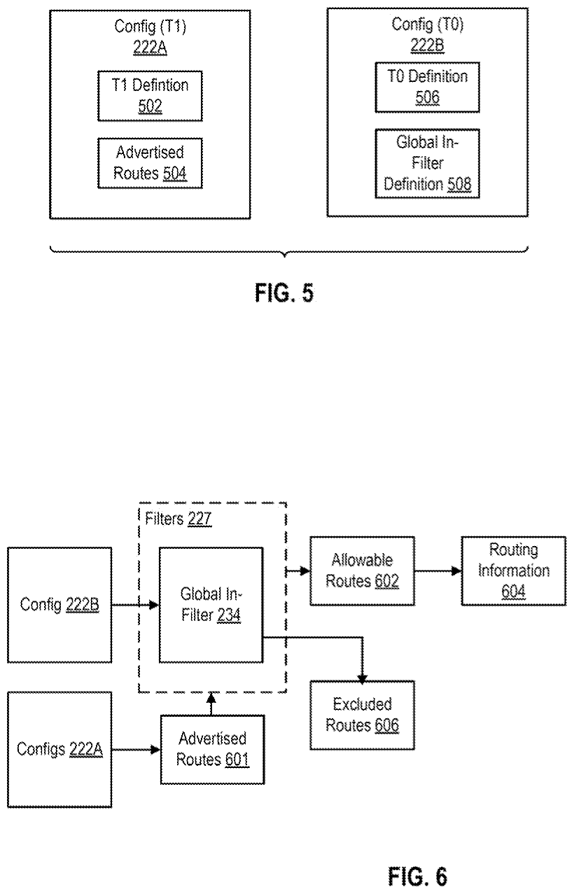

FIG. 6 is a block diagram depicting an exemplary logical operation of control plane 70 when processing advertised routes given a defined global in-filter. A provider user interacts with control plane 70 to generate config 222B having global in-filter definition 508 for t0 router 10. Tenant users interact with control plane 70 to generate configs 222A each having advertised routes 504 for a t1 router 24. Control plane 70 creates or updates global in-filter 234 in filters 227 with global in-filter definition 508. Control plane 70 applies advertised routes 601, which comprise advertised routes 504 from each config 222A, to filters 227, including global in-filter 234. Global in-filter 234 allows some advertised routes 601 (“allowable routes 602”) and denies some other advertised routes 601 (“excluded routes 606”). Control plane 70 generates routing information 604 that includes allowable routes 602. Routing information 604 can include other information, such as other routes (e.g., static routes created by provider user, routes learned by t0 router 10 from external network 30, etc.) and information on which routes t0 router can advertise.

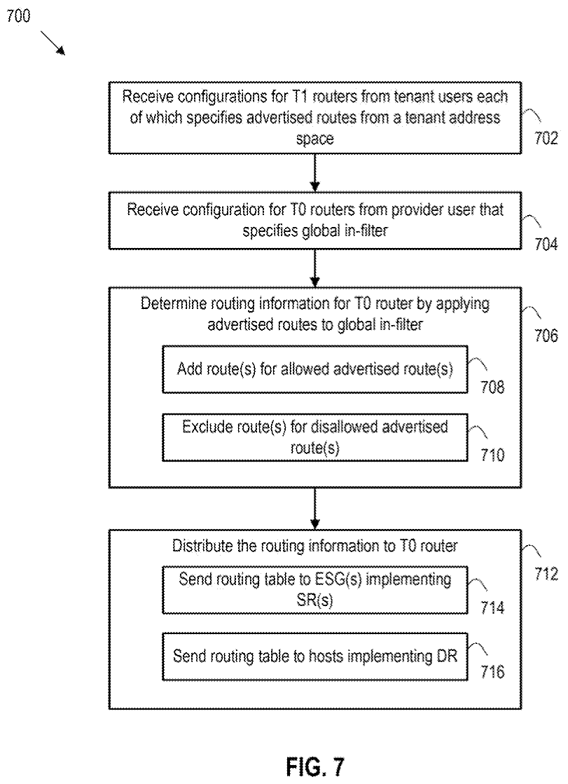

FIG. 7 is a flow diagram depicting an exemplary method 700 of implementing a logical network in an SDDC. Method 700 begins at step 702, where control plane 70 receives configurations for t1 routers 24 from tenant users each of which specifies advertised routes from their tenant address spaces. At step 704, control plane 70 receives a configuration for t0 router 10 from a provider user that defines or updates a global in-filter for t0 router 10. The global in-filter specifies a global network policy applied to all southbound logical routers for t0 router 10. In an embodiment, the provider user can define a chain of global in-filters as described above.

At step 706, control plane 70 determines routing information for t0 router 10 by applying the advertised routes for t1 routers 24 to the global in-filter (or chain of global in-filters). At step 708, control plane 70 adds route(s) for allowed advertised route(s). At step 710, control plane 70 excludes route(s) for disallowed advertised route(s). At step 712, control plane 70 distributes the routing information to t0 router 10. For example, at step 714, control plane 70 sends routing table(s) to ESG(s) implementing SR(s) of t0 router 10. At step 716, control plane 70 sends a routing table to hosts that implement a distributed router of t0 router 10.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The terms computer readable medium or non-transitory computer readable medium refer to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that, unless otherwise stated, one or more of these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in user-space on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific configurations. Other allocations of functionality are envisioned and may fall within the scope of the appended claims. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of implementing a logical network in a software-defined data center (SDDC), the method comprising:
receiving, at a control plane of the SDDC, first configurations for first logical routers comprising advertised routes and a second configuration for a second logical router comprising a global in-filter, the global in-filter including filter rules, applicable to all southbound logical routers, which determine a set of allowable routes for the second logical router, the first logical routers connected to a southbound interface of the second logical router;
determining, based on the filter rules, that a first advertised route of the advertised routes is an allowed route;
determining, based on the filter rules, that a second advertised route of the advertised routes is a disallowed route; and
distributing, from the control plane, routing information to a host of the SDDC that implements at least a portion of the second logical router, the routing information including a route for the first advertised route and excluding any route for the second advertised route.

2. The method of claim 1, wherein the first logical routers comprise gateways between tenant address spaces and the second logical router, the second logical router being a provider gateway outside of the tenant address spaces.

3. The method of claim 1, wherein the global in-filter further includes a list having a set of network addresses, and wherein the filter rules comprise a first rule disallowing any route for any network address in the set of network addresses and a second rule allowing any route from a selected logical router of the first logical routers, the second rule having precedence over the first rule.

4. The method of claim 3, wherein the first advertised route is for a network address in the set of network addresses, but from the selected logical router of the first logical routers.

5. The method of claim 3, wherein the second advertised route is for a network address in the set of network addresses and from any of the logical routers other than the selected logical router.

6. The method of claim 3, wherein the list includes a default action, wherein the first rule applies the default action, and wherein the second rule includes an action that overrides the default action.

7. The method of claim 1, wherein the filter rules comprise a plurality of rules applied in order from highest precedence to lowest precedence, a default rule of the plurality of rules having the lowest precedence and allowing or denying any advertised route.

8. The method of claim 1, wherein the second logical router comprises a centralized routing component executing in the host and a distributed routing component executing in other hosts of the SDDC, and wherein the routing information comprises a first routing table for the centralized routing component and a second routing table for the distributed routing component.

9. The method of claim 8, wherein the host comprises an edge services gateway that executes the centralized routing component, and wherein the other hosts include hypervisors having managed forwarding elements (MFEs) that execute the distributed routing component.

10. The method of claim 8, wherein the centralized routing component advertises the route in the routing information to at least one external physical router.

11. A non-transitory computer readable medium comprising instructions to be executed in a computing device to cause the computing device to carry out a method of implementing a logical network in a software-defined data center (SDDC), the method comprising:
receiving, at a control plane of the SDDC, first configurations for first logical routers comprising advertised routes and a second configuration for a second logical router comprising a global in-filter, the global in-filter including filter rules, applicable to all southbound logical routers, which determine a set of allowable routes for the second logical router, the first logical routers connected to a southbound interface of the second logical router;
determining, based on the filter rules, that a first advertised route is an allowed route;
determining, based on the filter rules, that a second advertised route is a disallowed route; and
distributing, from the control plane, routing information to a host of the SDDC that implements at least a portion of the second logical router, the routing information including a route for the first advertised route and excluding any route for the second advertised route.

12. The non-transitory computer readable medium of claim 11, wherein the first logical routers comprise gateways between tenant address spaces and the second logical router, the second logical router being a provider gateway outside of the tenant address spaces.

13. The non-transitory computer readable medium of claim 11, wherein the global in-filter further includes a list having a set of network addresses, and wherein the filter rules comprise a first rule disallowing any route for any network address in the set of network addresses and a second rule allowing any route from a selected logical router of the first logical routers, the second rule taking precedence over the first rule.

14. The non-transitory computer readable medium of claim 11, wherein the filter rules comprise a plurality of rules applied in order from highest precedence to lowest precedence, a default rule of the plurality of rules having the lowest precedence and allowing or denying any advertised route.

15. A computing system, comprising:
a hardware platform; and
a control plane, executing on the hardware platform, configured to implement a logical network in a software-defined data center (SDDC), the control plane configured to:
receive first configurations for first logical routers comprising advertised routes and a second configuration for a second logical router comprising a global in-filter, the global in-filter including filter rules, applicable to all southbound logical routers, which determine a set of allowable routes for the second logical router, the first logical routers connected to a southbound interface of the second logical router;
determine, based on the filter rules, that a first advertised route is an allowed route;
determine, based on the filter rules, that a second advertised route is a disallowed route; and
distribute routing information to a host of the SDDC that implements at least a portion of the second logical router, the routing information including a route for the first advertised route and excluding any route for the second advertised route.

16. The computing system of claim 15, wherein the first logical routers comprise gateways between tenant address spaces and the second logical router, the second logical router being a provider gateway outside of the tenant address spaces.

17. The computing system of claim 15, wherein the global in-filter further includes a list having a set of network addresses, and wherein the filter rules comprise a first rule disallowing any route for any network address in the set of network addresses and a second rule allowing any route from a selected logical router of the first logical routers, the second rule taking precedence over the first rule.

18. The computing system of claim 15, wherein the filter rules comprise a plurality of rules applied in order from highest precedence to lowest precedence, a default rule of the plurality of rules having the lowest precedence and allowing or denying any advertised route.

19. The computing system of claim 15, wherein the second logical router comprises a centralized routing component executing in the host and a distributed routing component executing in other hosts of the SDDC, and wherein the routing information comprises a first routing table for the centralized routing component and a second routing table for the distributed routing component.

20. The computing system of claim 19, wherein the host comprises an edge services gateway that executes the centralized routing component, and wherein the other hosts include hypervisors having managed forwarding elements (MFEs) that execute the distributed routing component.
